(19) United States
(12) Patent Application Publication
(10) Pub. No.: US 2022/0383125 A1
(43) Pub. Date: Dec. 1, 2022

(54) MACHINE LEARNING AIDED AUTOMATIC TAXONOMY FOR MARKETING AUTOMATION AND CUSTOMER RELATIONSHIP MANAGEMENT SYSTEMS

(71) Applicant: 6SENSE INSIGHTS, INC., San Francisco, CA (US)

(72) Inventors: Rohit KEWALRAMANI, Pune (IN); Justin CHIEN, Campbell, CA (US)

(21) Appl. No.: 17/828,361

(22) Filed: May 31, 2022

Related U.S. Application Data
(60) Provisional application No. 63/195,565, filed on Jun. 1, 2021.

(51) Int. Cl. G06N 3/08; G06N 3/04; G06F 16/28; G06F 16/955; G06Q 30/00

(52) U.S. Cl. CPC G06N 3/082; G06N 3/0472; G06F 16/283; G06F 16/955; G06Q 30/016

(57) ABSTRACT

Machine-learning-aided automatic taxonomy for marketing automation and customer relationship management. In an embodiment, a plurality of machine-learning models are trained to classify activity records into action, channel, and type classes, using a training dataset of annotated features. During operation, relevant features may be extracted from each activity record, and each model may be applied to a respective set of those features to classify the activity record into an action class, channel class, and type class. These classes may then be stored in association with the activity record as a taxonomized activity record.

### CROSS-REFERENCE TO RELATED APPLICATIONS

This application claims priority to U.S. Provisional Patent App. No. 63/195,565, filed on Jun. 1, 2021, which is hereby incorporated herein by reference as if set forth in full. In addition, this application is related to U.S. Pat. No. 9,202,227, issued on Dec. 1, 2015, U.S. Pat. No. 10,475,056, issued on Nov. 12, 2019, U.S. Pat. No. 10,536,427, issued on Jan. 14, 2020, U.S. Pat. No. 10,873,560, issued on Dec. 22, 2020, U.S. patent application Ser. No. 17/362,605, filed on Jun. 29, 2021, U.S. patent application Ser. No. 17/362,646, filed on Jun. 29, 2021, and U.S. application Ser. No. 17/362,843, filed on Jun. 29, 2021, which are all hereby incorporated herein by reference as if set forth in full.

### BACKGROUND

### Field of the Invention

The embodiments described herein are generally directed to artificial intelligence (AI), and, more particularly, to machine-learning-aided automatic taxonomy for marketing automation and customer relationship management systems.

### Description of the Related Art

Different systems, such as marketing automation platforms (MAPs), customer relationship management (CRM) systems, and websites, organize records differently. Thus, a platform that receives data from these different systems, as data sources, must utilize a taxonomy to aggregate records from these data sources. A taxonomy maps data from different data sources into a common and consistent labeling system to ensure compatibility with downstream functions. Without a taxonomy, the downstream functions may be unable to understand the data.

Conventionally, the creation of a taxonomy requires a labor-intensive collaborative process between the data aggregator and each of the data sources. The data aggregator must understand the structure of the data in order to build a taxonomy that maps the data to standardized fields for use with downstream functions. Due to various obstacles to automation, such as scalability and repeatability, this process must traditionally be performed manually. Not only does such a process cost a vast amount of time and effort, but it allows the introduction of a significant amount of human error.

Thus, what is needed is a solution to the obstacles preventing automation of the process for managing a taxonomy, and particularly, in the context of MAPs and CRM systems.

### SUMMARY

Accordingly, systems, methods, and non-transitory computer-readable media are disclosed for machine-learning-aided automatic taxonomy for MAPs and CRM systems.

In an embodiment, a method comprises using at least one hardware processor to: during a training mode, train each of a plurality of models to predict a class, from a plurality of classes in a different one of a plurality of taxonomies than any other one of the plurality of models, based on a training dataset that comprises a plurality of annotated features, wherein the plurality of models comprises an action model that predicts a class in a taxonomy of actions, a channel model that predicts a class in a taxonomy of channels, and a type model that predicts a class in a taxonomy of types; and, during an operation mode, acquire data comprising one or more activity records, for each of the one or more activity records, extract action features, channel features, and type features from the activity record, apply the action model to the action features to predict an action class from the taxonomy of actions, apply the channel model to the channel features to predict a channel class from the taxonomy of channels, apply the type model to the type features to predict a type class from the taxonomy of types, and store the predicted action class, the predicted channel class, and the predicted type class in association with the activity record as a taxonomized activity record.

Extracting the action features, extracting the channel features, and extracting the type features may each comprise: deriving one or more keywords from the activity record; and converting the one or more keywords into a vector according to a vectorization function. Each vector may have a fixed number of dimensions and represent an embedding of the one or more keywords within a vector space having the fixed number of dimensions. The vectorization function may be a language transformer. The vector may comprise a real value for each of the fixed number of dimensions. Extracting the action features, extracting the channel features, and extracting the type features may each further comprise, normalizing the one or more keywords prior to converting the one or more keywords into the vector.

Each of the plurality of models may comprise a deep neural network. Training each of the plurality of models may comprise adding one or more layers to an existing neural network trained for natural language processing, while neuron weights in one or more layers of the existing neural network are frozen. Each of the plurality of models may output both a predicted class and a probability value for the predicted class, wherein the method further comprises using the at least one hardware processor to, during the operation mode, for each of the one or more activity records: when the probability values for the predicted classes by all of the plurality of models satisfy respective thresholds, assign a mapped status to the activity record; and, when the probability value for the predicted class from at least one of the plurality of models does not satisfy the respective threshold, assign an unmapped status to the activity record. The method may further comprise using the at least one hardware processor to: generate a graphical user interface that comprises, for each of the activity records to which the unmapped status has been assigned, one or more inputs for specifying one of the plurality of classes in two or more of the plurality of taxonomies to be associated with that activity record; and, in response to a user operation to save one of the activity records to which the unmapped status has been assigned, store any specified classes in association with the one activity record, and assign the mapped status to the one activity record. The method may further comprise using the at least one hardware processor to generate a graphical user interface that comprises one or more inputs for changing each of one or both of the stored action class and the stored channel class to an overriding class in one or more of the taxonomized activity records, and at least one input for storing the one or more taxonomized activity records, including any overriding classes, in a data warehouse.

The method may further comprise using the at least one hardware processor to generate at least one lookup table from the data warehouse, wherein the at least one lookup table indexes one or more of: the action class in each of one or more of the taxonomized activity records in the data warehouse by the action features of that taxonomized activity record; the channel class in each of one or more of the taxonomized activity records in the data warehouse by the channel features of that taxonomized activity record; or the type class in each of one or more of the taxonomized activity records in the data warehouse by the type features of that taxonomized activity record. The method may further comprise using the at least one hardware processor to, for each of one or more activity records, for each of the plurality of models: perform a lookup in the at least one lookup table using features extracted for that model from the activity record; when the lookup returns a class, store the returned class in association with the activity record as the taxonomized activity record without applying the model; and, when the lookup does not return a class, extract the features for that model, and apply the model to the extracted features.

The plurality of models may further comprise a web model that predicts a class in a taxonomy of web activities, wherein the method further comprises using the at least one hardware processor to, during the operation mode, for each of the one or more activity records, when the activity record contains a uniform resource locator (URL): extract web features from the activity record; apply the web model to the web features to predict a web activity from the taxonomy of web activities; and store the predicted web activity in association with the activity record in the taxonomized activity record. During the operation mode, for each of the one or more activity records, when the activity record contains a URL, the predicted web activity may be associated with the activity record in the taxonomized activity record instead of the predicted type class.

The plurality of models may comprise a plurality of action models, a plurality of channel models, and a plurality of type models, wherein the method further comprises using the at least one hardware processor to, during the operation mode, select one of the plurality of action models, one of the plurality of channel models, and one of the plurality of type models based on a type of data source from which the data was acquired. A first combination of one of the plurality of action models, one of the plurality of channel models, and one of the plurality of type models may be selected when the type of data source is a marketing automation platform, and a second combination of one of the plurality of action models, one of the plurality of channel models, and one of the plurality of type models may be selected when the type of data source is a customer relationship management system, wherein the first combination is different than the second combination. A first combination of one of the plurality of action models, one of the plurality of channel models, and one of the plurality of type models may be selected when the type of data source is a marketing automation platform, a second combination of one of the plurality of action models, one of the plurality of channel models, and one of the plurality of type models may be selected when the type of data source is campaign data of a customer relationship management system, and a third combination of one of the plurality of action models, one of the plurality of channel models, and one of the plurality of type models may be selected when the type of data source is event data of a customer relationship management system, wherein the first combination, the second combination, and the third combination are different from each other.

Any of the methods above may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a process for automating a taxonomy, using prediction models, according to an embodiment;

FIGS. 4A-4D illustrate exemplary screens of a graphical user interface, according to embodiments; and

FIG. 5 illustrates an example deep neural network to be used as a prediction model, according to an embodiment.

### DETAILED DESCRIPTION

In an embodiment, systems, methods, and non-transitory computer-readable media are disclosed for machine-learning-aided automatic taxonomy for MAPs and CRM systems. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

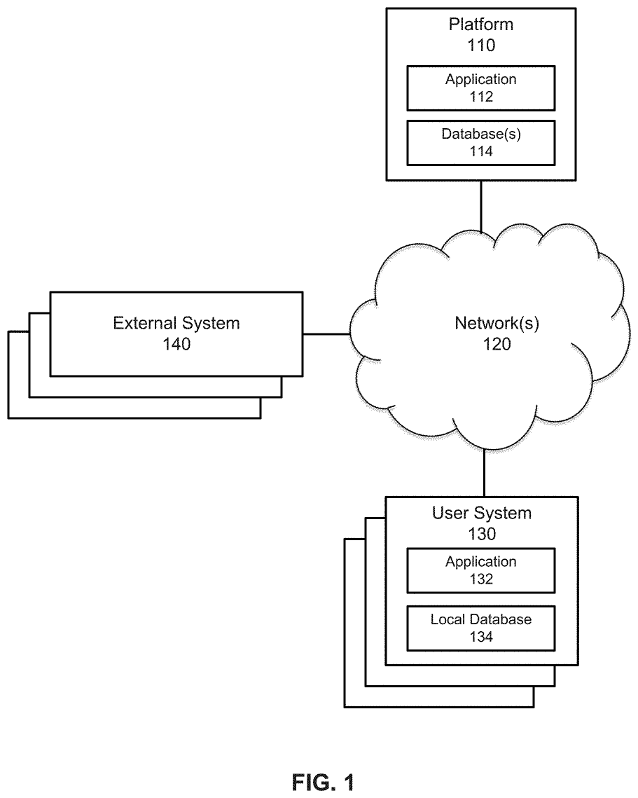

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated hardware servers, or may instead comprise cloud servers, which utilize shared resources of one or more hardware servers. In any case, these servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. It is generally contemplated that user system(s) 130 would comprise desktop computers, workstations, and/or mobile devices that users typically utilize during performance of their normal job responsibilities for an employer. Each user may utilize their user system 130 to create and/or access a user account with platform 110 that enables them to authenticate with and access any of the functions of platforms 110 (e.g., as implemented in server application 112) for which the user has an appropriate role or appropriate permissions, during a secure session.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132 may utilize a local database 134 for storing data locally on user system 130. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

1.2. Example Processing Device

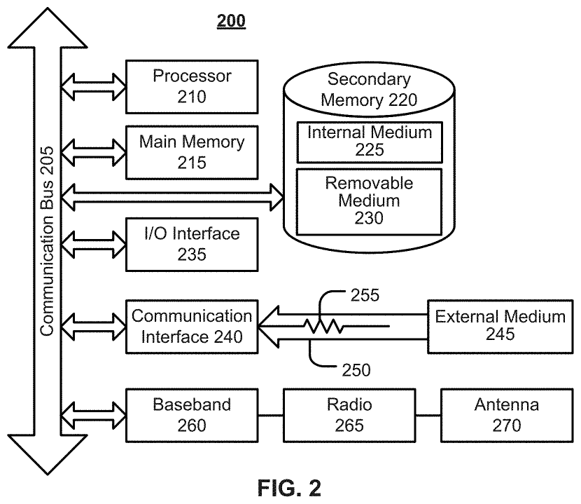

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a secondary processor subordinate to the main processing system (e.g., backend processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like. Secondary memory 220 is a non-transitory computer-readable medium having computer-executable code (e.g., disclosed software modules) and/or other data stored thereon. The computer software or data stored on secondary memory 220 is read into main memory 215 for execution by processor 210. In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer programs (e.g., computer-executable code implementing the disclosed software) are stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

As used herein, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, printers, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information (e.g., for a user system comprising a smartphone), then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, may enable system 200 to perform the various functions of the disclosed embodiments.

2. Process Overview

Embodiments of processes for machine-learning-aided automatic taxonomy for MAPs and CRM systems will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

2.1. Operation

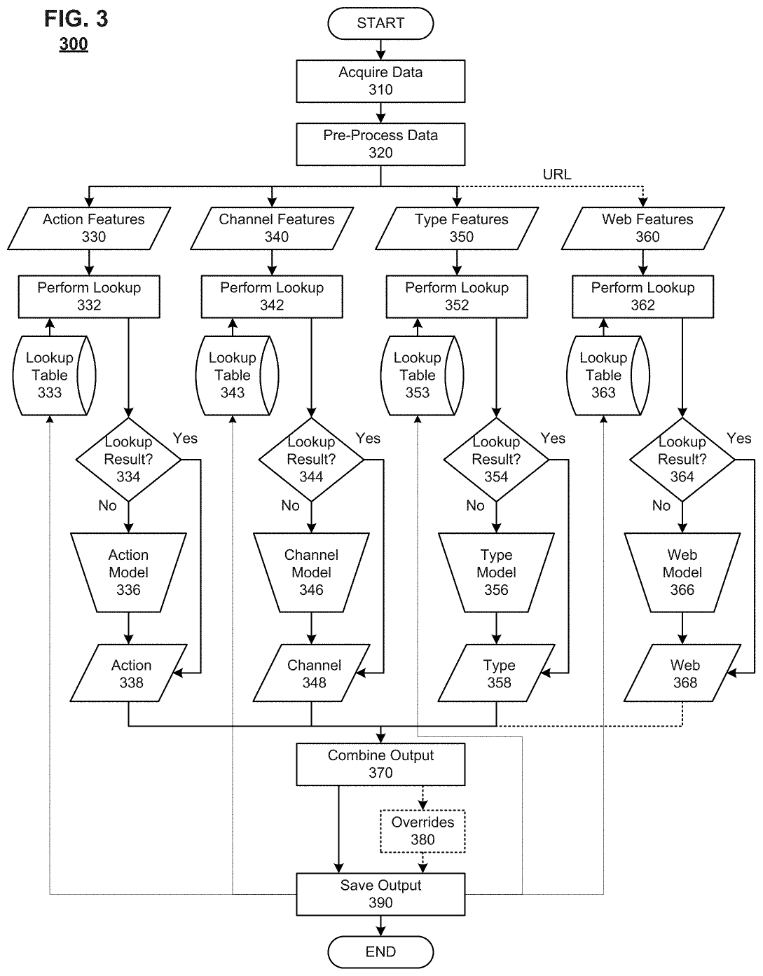

FIG. 3 illustrates a process 300 for automating a taxonomy, using prediction models that act as taxonomic classifiers, according to an embodiment. In an embodiment, process 300 is implemented by server application 112 on platform 110. However, in alternative embodiments, process 300 could be implemented by client application 132 on user system 130, or as a distributed software application with some subprocesses implemented by server application 112 and other subprocesses implemented by client application 132. In any case, process 300 may be performed iteratively or periodically (e.g., daily), in real time as data is received, after a certain amount of data is received, in response to a user operation, and/or the like. Process 300 may be performed independently for data associated with each organization (e.g., company selling one or more products, such as a good or service) that has an organizational account with platform 110. One or more users (e.g., employees or other agents of the organization) may have a user account under this organizational account with individual authentication credentials for independently logging into the user account and managing the organization's data for which they are responsible. Alternatively, the organizational account may be a single user account with a single set of authentication credentials. In either case, a user may utilize authentication credentials to log in to server application to access and manage data and settings associated with the organization.

In subprocess 310, data, comprising one or a plurality of activity records, are received or otherwise acquired. The data may be acquired from one or more external systems 140, such as a MAP and/or CRM system that are managed and utilized by a user's organization and configured to interface with platform 110 under the organizational account (e.g., using user-specified settings). A MAP is a software platform that automates repetitive tasks that enable an organization to more effectively market on multiple channels (e.g., email, social media, websites, etc.). A MAP will generally provide a dashboard that enables marketing personnel to plan, coordinate, manage, and measure online and offline marketing campaigns, and to manage leads (i.e., potential customers) generated by the marketing campaigns, with the goal of converting those leads into actual customers (i.e., purchasers of a product offered by the organization). Examples of MAPs include the Marketo™ products offered by Marketo, Inc. of San Mateo, Calif., the Eloqua™ product offered by Oracle Corp. of Austin, Tex., the Pardot™ product offered by Salesforce.com, Inc. of San Francisco, Calif., the products offered by Hubspot, Inc., of Cambridge, Mass., and the like. A CRM system compiles data about past, present, and potential customers from an organization's various communication channels (e.g., website, telephone, email, real-time chat, social media, etc.), and may provide various tools for managing those customers. An example of a CRM system is the CRM software offered by Salesforce.com, Inc. of San Francisco, Calif. While MAPs and CRM systems are the most well-known types of systems for collecting activity records for customers, it should be understood that any system capable of collecting activity records for customers (e.g., past, present, and/or potential customers) may be a source of the data acquired in subprocess 310. For example, in an embodiment, a beacon may be installed on a web site of an external system 140 to track the activities and IP addresses of visitors to the web site and store the tracked data as activity records.

Regardless of the type of system, external system 140 may communicate these activity records to platform 110 over network(s) 120. For example, external system 140 may “push” the activity records to platform 110 via an API of platform 110. Alternatively, platform 110 may “pull” the activity records from external system 140 via an API of external system 140. As another alternative, the activity records may be manually uploaded to platform 110 by a user through a user account registered with platform 110. In any case, an activity record may represent any online or offline activity, such as visits to a webpage of a web site (e.g., a homepage or product site of an organization), clicking a hyperlink (e.g., in an email message of a marketing campaign), submissions of online forms on web sites (e.g., search query, contact form, request for a price quote for a product, job submission, conference or tradeshow registration, product trial, etc.), downloads of electronic documents from web sites (e.g., white paper, etc.), playback of media (e.g., videos, webinars, demonstrations, etc.) on websites, subscription or un-subscription from a news or other media feed, attendance of a conference or tradeshow, a telephone call to a customer service representative, a real-time chat with a bot or human customer service representative, an in-store visit, engagement with a social media post from the organization (e.g., a repost, “like,” comment, etc.), engagement with an online discussion forum, and/or the like.

In subprocess 320, the data is pre-processed. In particular, the data may be normalized or standardized from its native schema (e.g., as represented in external system 140) to a common schema used by platform 110. In other words, all of the data, in different formats from disparate sources, are converted into a common format. In addition, the text in the data may be normalized or standardized according to a fixed sequence of pre-processing steps. For example, the text may be normalized by separating each word in camel case into separate words, replacing symbols with spaces, replacing text in unsupported languages (e.g., non-English text) with spaces, replacing numbers with spaces, converting multiple consecutive spaces to a single space, expanding acronyms, expanding contractions, converting all text to lowercase, and/or the like.

In an embodiment, the common schema may define a common intermediate representation. For example, each external system 140 (e.g., MAP, CRM system, etc.) that provides data may store and manage that data using its own set of tables that have been defined using proprietary choices of fields and data types. Subprocess 320 may extract all relevant and usable information from the tables of each of these different data sources into a common intermediate representation of each activity represented in the proprietary tables of that data source. The common intermediate representation may comprise one or more tables, with a standard, fixed structure, that assemble the relevant data for each activity record. Advantageously, the table(s) of the common intermediate representation have a fixed structure according to the common schema, so that features can be extracted from the same columns during each iteration of subprocess 300. This enables automation of the taxonomy. Notably, not all columns in the table(s) in the common intermediate representation will necessarily be populated with data for activity records from a given data source, since the data source may not have data that corresponds to all columns in the fixed structure of the table(s) in the common intermediate representation.

After pre-processing, the data comprise one or a plurality of activity records represented in the common intermediate representation. From each of these activity records, a set of one or more features may be extracted for each of the models to be applied. In an embodiment, a plurality of different models, which are each associated with a different taxonomy for a different attribute of the activities represented by the activity records, are applied to the activity records. For example, in an embodiment, action features 330 are extracted for an action model 336, channel features 340 are extracted for a channel model 346, and type features 350 are extracted for a type model 356. In addition, in the event that an activity record contains a uniform resource locator (URL) for an online resource, web features 360 may be extracted for a web model 366. In general, activity records acquired from MAPs will typically comprise URLs, such that web features 360 may be extracted for web model 366. In the other hand, activity records acquired from CRM systems will typically not comprise URLs, such that no web features need to be extracted, in which case blocks 360-368 may be omitted.

Examples of relevant data that may be normalized and stored in the common intermediate representation for each activity record that is acquired from a MAP may include, without limitation, a user identifier, user activity, type of user activity, details of user activity, Internet Protocol (IP) address of the user, identifier of the marketing campaign associated with the user activity, name of the marketing campaign, description of the marketing campaign, URL associated with web visit, referrer (e.g., address of the webpage that referred the user to the URL), click event in an email message (e.g., sent as part of the marketing campaign), subject of the email message, body of the email message, email address (e.g., from which the email message was sent), description of program used, asset, name of form that was submitted, date of user activity, date of activity record, and/or the like. In an embodiment, when the data source of activity records is a MAP, the type of user activity, the name of the marketing campaign, and the description of the marketing campaign are extracted from each activity record as each of action features 330, channel features 340, and type features 350. Examples of relevant data that may be normalized and stored in the common intermediate representation for each activity record that is acquired for campaign(s) from a CRM system may include, without limitation, an identifier of a campaign, name of the campaign, type of the campaign, description of the campaign, campaign member identifier, campaign member status, campaign member description, contact email, lead email, date of activity record, and/or the like. Examples of relevant data that may be normalized and stored in the common intermediate representation for each activity record that is acquired for event(s) in scheduling information (e.g., synched from a calendar, meeting schedule, etc.) from a CRM system may include, without limitation, type of source, event identifier, attendee identifier(s), subject of the event, location of the event, duration of the event, description of the event, type of the event, whether or not the event is recurring, date of the event, date of the record, and/or the like. It should be understood that, even though the features extracted from a given activity record may comprise a type (e.g., type of source, type of event, etc.), this type may differ from the predicted type 358 that will be output by type model 356. In particular, the value of the predicted type 358 will be a class within a taxonomy of types used by platform 110, whereas the type in the features will have an arbitrary value defined by the data source (e.g., external system 140) that will typically not directly correspond to a class within the taxonomy used by platform 110.

Action features 330, channel features 340, and type features 350 may be different or may be the same for a given activity record. In an embodiment, features 330, 340, and 350 are each generated by concatenating text from one or a plurality, including potentially all, of the columns in the table(s) of the common intermediate representation for a given activity record into a single character string. It should be understood that, when features 330, 340, and/or 350 are different from each other, they may be derived from different, overlapping or nonoverlapping, sets of the columns than each other. For example, for campaign data from a CRM system, action features 330 and channel features 340 may comprise or consist of the type of the campaign and the campaign member status, whereas type features 350 may comprise or consist of the type of the campaign, the campaign member status, the name of the campaign, and the description of the campaign. The addition of the name and description of the campaign in type features 350 facilitates a determination of the kind of campaign of which the represented activity is a part. As another example, for event data from a CRM system, action features 330 may comprise or consist of the subject of the event and the type of source, channel features 340 may comprise or consist of the subject of the event, the type of source, and the location of the event, and type features 350 may comprise or consist of the subject of the event, the type of source, and the description of the event. In the event that an activity record contains a URL, web features 360 for that activity record may comprise the concatenation of one or more components of the URL (e.g., protocol, subdomain, domain, path, query, parameters, fragments, etc.) and metadata about the online resource located at the URL (e.g., title, description, keywords, and metatags embedded in the HTML source code, HTML events, etc.). For each activity record, the concatenation of text from the column(s) in the table(s) of the common intermediate representation for that activity record may result in a feature string, comprising one word or a plurality of words separated by spaces, for each of models 336, 346, 356, and 366.

Each of the final features 330, 340, 350, and/or 360 may then be generated as a feature vector from the respective feature string using a vectorization function. Vectorization is performed to enable computers and models to more easily process text at a low level. In an embodiment of the vectorization in subprocess 320, each feature string is converted into a fixed-dimensional vector according to a vector space model for producing textual embeddings. In particular, a feature string X is input into a vectorization function F_{V} that outputs an N-dimensional vector V (i.e., F_{V}(X)=V). For example:

F_{V}(“Today is a good day!”)=[v₁,v₂,v₃, . . . ,v_{N}]=[0.435,−1.923,−0.553, . . . ,0.123]

Thus, in an embodiment, the output of subprocess 320 is an N-dimensional vector V for each of the feature strings for each of models 336, 346, 356, and 366 (if applicable), for each of the activity records in the data acquired in subprocess 310. In other words, each of action features 330, channel features 340, type features 350, and web features 360 (if applicable), may comprise an N-dimensional vector V, and each activity record produces a set of action features 330, channel features 340, type features 350, and web features 360 (if applicable). It should be understood that N is the number of dimensions in the particular vector space being used for vectorization function F_{V}.

The choice of vectorization function F_{V} depends on the nature and complexity of the problem. In an embodiment, a language transformer is used as the vectorization function F_{V}, such as the Universal Sentence Encoder by Google LLC of Mountain View, Calif. A language transformer is a deep-learning model that accepts a natural-language sentence as input and outputs an N-dimensional real-valued vector representing the position of the sentence in an N-dimensional vector space. In particular, each output vector encodes the meaning of the input sentence, such that sentences whose vectors are closer to each other in the N-dimensional vector space are more similar in meaning than sentences whose vectors are farther from each other in the N-dimensional vector space. In the case of the Universal Sentence Encoder, N=512, such that each output vector consists of 512 real values. It should be understood that this is only one non-limiting example, and that other models may be used for vectorization function F_{V}. However, it is beneficial for the vectorization function F_{V} to be context-aware, since many feature strings will include phrases (e.g., “sent email,” “filled out form,” etc.), sentences, and even short paragraphs. In addition, different data sources will use different wordings, and using a context-aware approach enables the models to work across multiple data sources, even when different wordings are used, including new types of data sources with similar types of data. In other words, a context-aware vectorization function F_{V} enables the artificial intelligence to understand the particular languages of all types of data sources.

In subprocess 332, for each set of action features 330, corresponding to an activity record, a lookup is performed using that set of action features 330 as an index into lookup table 333. Lookup table 333 associates previously extracted sets of action features 330 with previously determined actions. A previously determined action in lookup table 333 may be an action 338 that was previously predicted by action model 336 and/or an action specified by a user, for example, to override a previously predicted action 338 (e.g., in subprocess 380, as discussed below). If a result (i.e., a previously determined action) is returned by the lookup performed in subprocess 332 (i.e., “Yes” in subprocess 334), that returned result is output as action 338 without applying action model 336. In other words, if the lookup in subprocess 332 is successful, action model 336 is bypassed to avoid unnecessary computation. This may occur each time an activity record is not unique from a previously seen activity record. For example, two different leads opening the same email from the same marketing campaign may result in the same activity record for each lead, and therefore, should be classified as the same action 338. Advantageously, bypassing action model 336 for previously seen action features 330 reduces runtime and complexity.

If no result or a null result is returned by the lookup performed in subprocess 332 (i.e., “No” in subprocess 334), action model 336 is applied to action features 330 for the current activity record under consideration to predict an action 338 for that activity record from a taxonomy of actions. In other words, action model 336 classifies each activity record, as represented by the action features 330 extracted from that activity record, into one of a plurality of classes representing actions within a taxonomy of actions. In an embodiment, different taxonomies of actions may be provided for different sources of the data. In this case, a different lookup table 333 and/or a different action model 336 may be chosen for process 300 based on the source of the data acquired in subprocess 310. For example, if the data is acquired from a MAP, the plurality of classes in the taxonomy of actions may comprise or consist of “attention,” “clicked,” “converted,” “deleted,” “error,” “filled,” “merge,” “sent,” “subscribed,” “unsubscribed,” “view,” and/or “other.” If the data is acquired from campaign data from a CRM system, the plurality of classes in the taxonomy of actions may comprise or consist of “attended,” “clicked,” “downloaded,” “error,” “engaged,” “filled,” “invited,” “negative,” “not attended,” “positive,” “responded,” “sent,” “unsubscribed,” “view,” and/or “other.” If the data is acquired from event data from a CRM system, the plurality of classes in the taxonomy of actions may comprise or consist of “attended,” “blocked,” “booked,” “invited,” “recorded,” and/or “sent.” It should be understood that all of the specific taxonomies disclosed herein are simply illustrative, non-limiting examples, to aid in the understanding of the present disclosure. While any taxonomy may be used with the disclosed embodiments, each model will typically work best when the learned classes in the taxonomy are clearly separable, such that the model can make clear predictions and drive associations between textual elements and learned classes.

In subprocess 342, for each set of channel features 340, corresponding to an activity record, a lookup is performed using that set of channel features 340 as an index into lookup table 343. Lookup table 343 associates previously extracted sets of channel features 340 with previously determined channels. A previously determined channel in lookup table 343 may be a channel 348 that was previously predicted by channel model 346 and/or a channel specified by a user, for example, to override a previously predicted channel 348 (e.g., in subprocess 380, as discussed below). If a result (i.e., a previously determined channel) is returned by the lookup performed in subprocess 342 (i.e., “Yes” in subprocess 344), that returned result is output as channel 348 without applying channel model 346. In other words, if the lookup in subprocess 342 is successful, channel model 346 is bypassed to avoid unnecessary computation.

If no result or a null result is returned by the lookup performed in subprocess 342 (i.e., “No” in subprocess 344), channel model 346 is applied to channel features 340 for the current activity record under consideration to predict a channel 348 for that activity record from a taxonomy of channels. In other words, channel model 346 classifies each activity record, as represented by the channel features 340 extracted from that activity record, into one of a plurality of classes representing channels within a taxonomy of channels. In an embodiment, different taxonomies of channels may be provided for different sources of the data. In this case, a different lookup table 343 and/or a different channel model 346 may be chosen for process 300 based on the source of the data acquired in subprocess 310. For example, if the data is acquired from a MAP, the plurality of classes in the taxonomy of channels may comprise or consist of “advertisement,” “alert,” “email,” “form,” “lead,” “marketer,” “salesforce.com,” “social,” “video,” “webpage,” and/or “other.” If the data is acquired from campaign data from a CRM system, the plurality of classes in the taxonomy of channels may comprise or consist of “advertisement,” “contact,” “direct,” “email,” “form,” “link,” “list,” “live,” “on-demand,” “online,” “search,” “social media,” “telemarketing,” “video,” and/or “webpage.” If the data is acquired from event data from a CRM system, the plurality of classes in the taxonomy of channels may comprise or consist of “call,” “meeting,” “virtual,” and/or “other.”

In subprocess 352, for each set of type features 350, corresponding to an activity record, a lookup is performed using that set of type features 350 as an index into lookup table 353. Lookup table 353 associates previously extracted sets of type features 350 with previously determined types. A previously determined type in lookup table 353 may be a type 358 that was previously predicted by type model 356 and/or a type specified by a user, for example, to override a previously predicted type 358 (e.g., in subprocess 380, as discussed below). If a result (i.e., a previously determined type) is returned by the lookup performed in subprocess 352 (i.e., “Yes” in subprocess 354), that returned result is output as type 358 without applying type model 356. In other words, if the lookup in subprocess 352 is successful, type model 356 is bypassed to avoid unnecessary computation.

If no result or a null result is returned by the lookup performed in subprocess 352 (i.e., “No” in subprocess 354), type model 356 is applied to type features 350 for the current activity record under consideration to predict a type 358 for that activity record from a taxonomy of types. In other words, type model 356 classifies each activity record, as represented by the type features 350 extracted from that activity record, into one of a plurality of classes representing types within a taxonomy of types. In an embodiment, different taxonomies of types may be provided for different sources of the data. In this case, a different lookup table 353 and/or a different type model 356 may be chosen for process 300 based on the source of the data acquired in subprocess 310. For example, if the data is acquired from a MAP, the plurality of classes in the taxonomy of types may comprise or consist of “webinar,” “event,” “content,” “conference/tradeshow,” “demand generation,” “nurture,” “demo,” “organic,” “mail,” “operational,” and/or “other.” If the data is acquired from campaign data from a CRM system, the plurality of classes in the taxonomy of types may comprise or consist of “content,” “demand generation,” “demo,” “mail,” “event,” “lead generation,” “nurture,” “trial,” “campaign,” “conference/tradeshow,” “webinar,” “workshop,” and/or “other.” If the data is acquired from event data from a CRM system, the plurality of classes in the taxonomy of types may comprise or consist of “demo,” “discovery,” “general,” “lunch,” “recurring,” “sales,” and/or “training.”

In subprocess 362, for each set of web features 360, corresponding to a URL in an activity record, a lookup is performed using that set of web features 360 as an index into lookup table 363. Lookup table 363 associates previously extracted sets of web features 360 with previously determined web activities. A previously determined web activity in lookup table 363 may be a web activity 368 that was previously predicted by web model 366 and/or a web activity specified by a user, for example, to override a previously predicted web activity 368 (e.g., in subprocess 380, as discussed below). If a result (i.e., a previously determined web activity) is returned by the lookup performed in subprocess 362 (i.e., “Yes” in subprocess 364), that returned result is output as web activity 368 without applying web model 366. In other words, if the lookup in subprocess 362 is successful, web model 366 is bypassed to avoid unnecessary computation.

If no result or a null result is returned by the lookup performed in subprocess 362 (i.e., “No” in subprocess 364), web model 366 is applied to web features 360 for a URL in the current activity record under consideration to predict a web activity 368 for that URL from a taxonomy of web activities. In other words, web model 366 classifies a URL in any activity record containing a URL, as represented by the web features 360 extracted from that activity record, into one of a plurality of classes within a taxonomy of web activities. For example, the plurality of classes in the taxonomy of web activities may comprise or consist of “product research,” “blogs,” “company research,” “campaign,” “search,” “case studies,” “solutions,” “whitepaper,” “contact us,” “demo,” “training,” “product trial,” “video,” “webinars,” “support,” “homepage,” “careers,” “conferences/tradeshows,” “pricing,” “communities,” “unsubscribed,” “product research,” “product landing page,” and/or “other.”

In an embodiment, each of models 336, 346, 356, and/or 366 is probabilistic. Thus, for each set of features (e.g., feature vector) that is input, the model 336, 345, 356, and/or 366 may output both the predicted class from the relevant taxonomy and a probability value of the predicted class for the set of features. The probability value represents a confidence that the predicted class is correct. In an embodiment, each model 336, 346, 356, and/or 366 outputs a probability vector that comprises a probability value for each of the plurality of classes in the relevant taxonomy. In this case, the size of the probability vector is the same as the number of classes in the taxonomy, and the probability values in a given probability vector may sum to 1.0. In an alternative embodiment, each model 336, 346, 356, and/or 366 may simply output the class with the highest probability value as the predicted class, along with that highest probability value.

Each output by each model 336, 346, 356, and/or 366, as action 338, channel 348, type 358, and/or web activity 368, for each activity record, may be post-processed. In particular, each prediction may be analyzed to determine whether or not that prediction should be accepted and/or how that prediction should be characterized. Each prediction may be characterized in binary terms, as either confident or non-confident. This post-processing may comprise determining whether or not the probability value for the predicted class with the highest probability value satisfies (e.g., exceeds) a predetermined threshold value. If the prediction satisfies the predetermined threshold, the prediction may be characterized as confident. Otherwise, if the prediction does not satisfy the predetermined threshold, the prediction may be characterized as non-confident. The value of the predetermined threshold for each model 336, 346, 356, and/or 366 may be determined during training of the respective model, based on the variation in predicted classes and their corresponding probability values during testing and evaluation. It should be understood that each model 336, 346, 356, and/or 366 may, but does not necessarily, have a different predetermined threshold than the other models. In an embodiment, if a prediction comprises two classes with very close probability values (e.g., within 1-3 percentage points, such as a first class with a probability value of 0.51 and a second class with a probability value of 0.49), the prediction may be characterized as non-confident, even if it satisfies the predetermined threshold. In such cases, simply selecting the predicted class with the highest probability value may frequently result in unreliable classifications. In any case in which the prediction is characterized as non-confident, the predicted class may be automatically overridden to null or a null class, to thereby negate the respective model's prediction.

In subprocess 370, for each activity record in the data, the action 338, channel 348, type 358, and web activity 368 (if applicable), determined for that activity record, are combined into a composite taxonomic classification for that activity record. In particular, in the illustrated embodiment, each activity record, in the data received in subprocess 310, may be associated with an action 338, channel 348, and type 358, assuming that each of these outputs has been characterized as confident. In addition, if the activity record contains a URL, the activity record will also be associated with a web activity 368, assuming that this output has been characterized as confident. Alternatively, if the activity record contains a URL, the type of the activity record may be replaced with the determined web activity (e.g., if the determined web activity has been characterized as confident). Each action 338 represents what a lead did (e.g., clicked a link, filled a form, visited a webpage, sent an email, etc.). Each channel 348 represents the medium through which the lead performed the associated action 338 (e.g., email, webpage, form, etc.). Each type 358 represents the type of content with which the associated action 338 is associated (e.g., homepage, demo, nurture, gift, etc.). Each web activity 368 represents the type of online resource at the URL in the associated activity record, and therefore, may be used instead of or in addition to type 358 for activity records that contain URLs.

In an embodiment, if action 338, channel 348, and type 358 and/or web activity 368 (if applicable) are all characterized as confident (e.g., satisfying the predetermined threshold value) for a given activity record, that activity record is associated with a status of “mapped.” Otherwise, if at least one of action 338, channel 348, and type 358 and/or web activity 368 is characterized as non-confident, that activity record may be associated with a status of “unmapped.” However, an alternative embodiment may define the statuses of “mapped” and “unmapped” in a different manner. For example, an activity record may be defined as “mapped” if at least one of action 338, channel 348, and type 358 and/or web activity 368 is characterized as confident or if a certain subset of action 338, channel 348, and type 358 and/or web activity 368 is characterized as confident, and otherwise, defined as “unmapped.”

In optional subprocess 380, one or more of the values of action 338, channel 348, type 358, and/or web activity 368 (if applicable), may be confirmed, overridden, and/or manually specified for a given activity record. For example, server application 112 may provide a graphical user interface that, when a user has logged into a respective user account, enables the user to manage the composite taxonomic classification for each activity record. In an embodiment, the classifications of all activity records that have been assigned the status of “unmapped” may be provided to a user, via the graphical user interface (e.g., in a dashboard screen of the user's user account), for manual classification via one or more inputs of the graphical user interface. The graphical user interface may also comprise one or more inputs for manually confirming and/or overriding the classifications of activity records that have been assigned the status of “mapped.” For example, the graphical user interface may provide, for each of the “mapped” and “unmapped” statuses, a list of all activity records to which the user has access or for which the user has responsibility. The user may select individual entries in the list, and, in response to the selection of an entry in the list, the graphical user interface may provide details about the entry and one or more inputs (e.g., a drop-down menu) for changing or specifying the class(es) to which the entry belongs and, optionally, for changing the status of the entry, for example, between “mapped” (e.g., if currently classified) or “unmapped” (e.g., if currently unclassified) and “do not map.” In the case of entries that correspond to activity records with the status of “mapped,” the input for changing the class may be pre-populated with the predicted class for that entry. Similarly, an input for changing the status of the entry may be pre-populated with the current status for that entry. Thus, the graphical user interface makes it easy for users to identify and rectify any classification mistakes.

The user may utilize the graphical user interface to perform, without limitation, one or more of the following actions on each activity record:
Override the predicted class for one or more of action 338, channel 348, and type 358 and/or web activity 368 (if applicable) with any other one of the plurality of classes in the relevant taxonomy, irrespective of the status (e.g., “mapped” or “unmapped”).
Change the status from “mapped” or “unmapped” to “do not map,” or vice versa. The “do not map” status indicates that the user intends to discard or ignore the activity record. For example, an activity record with a “do not map” status is not propagated to subprocess 390.
Change the status from “unmapped” to “mapped,” or vice versa.
In an embodiment, the statuses include a “mapped but needs confirmation” status. This status indicates that explicit attention by the user is requested. The “mapped but needs confirmation” status may be assigned to activity records for which the highest probability value of one or more of action 338, channel 348, and type 358 and/or web activity 368 (if applicable) is very close to the second highest probability value (e.g., within 1 to 3 percentage points), such that the predicted class may be unreliable. The user may review each activity record with a “mapped but needs confirmation status” and confirm or change the class for one or more of the action 338, channel 348, and type 358 and/or web activity 368 (if applicable) associated with that activity record. Once the user confirms or changes the class(es), the status of the activity record may be automatically updated to “mapped.”

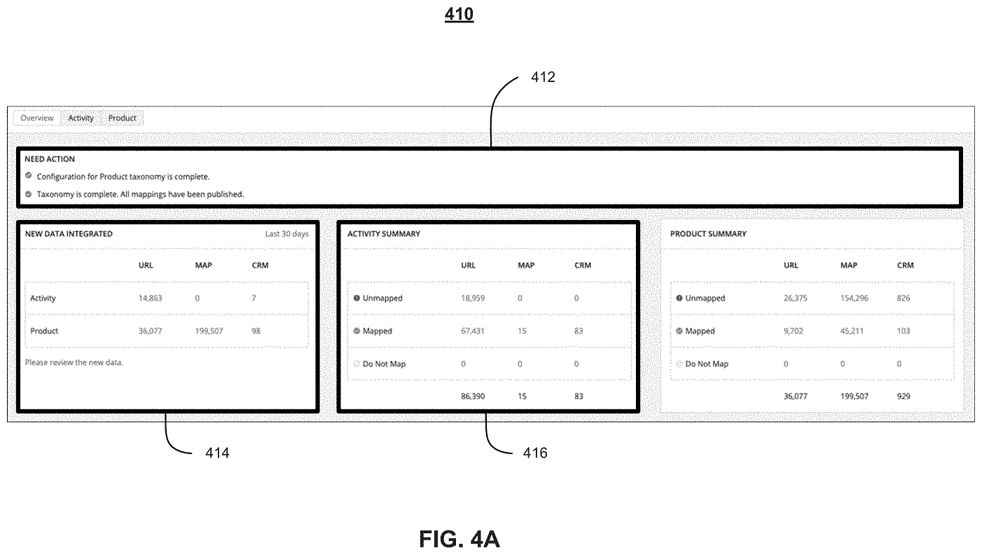

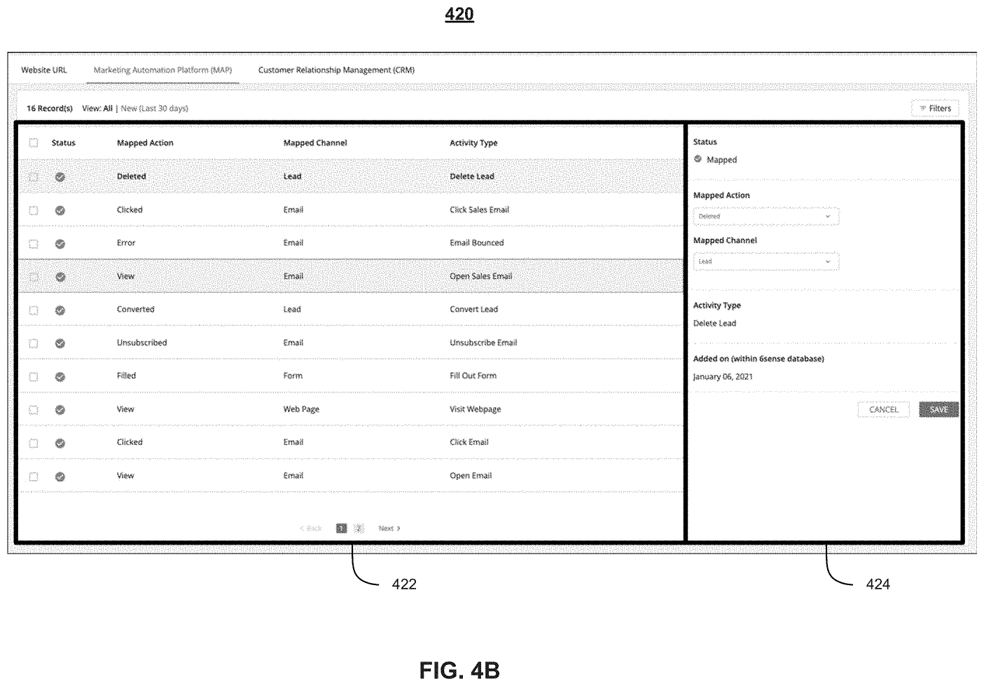

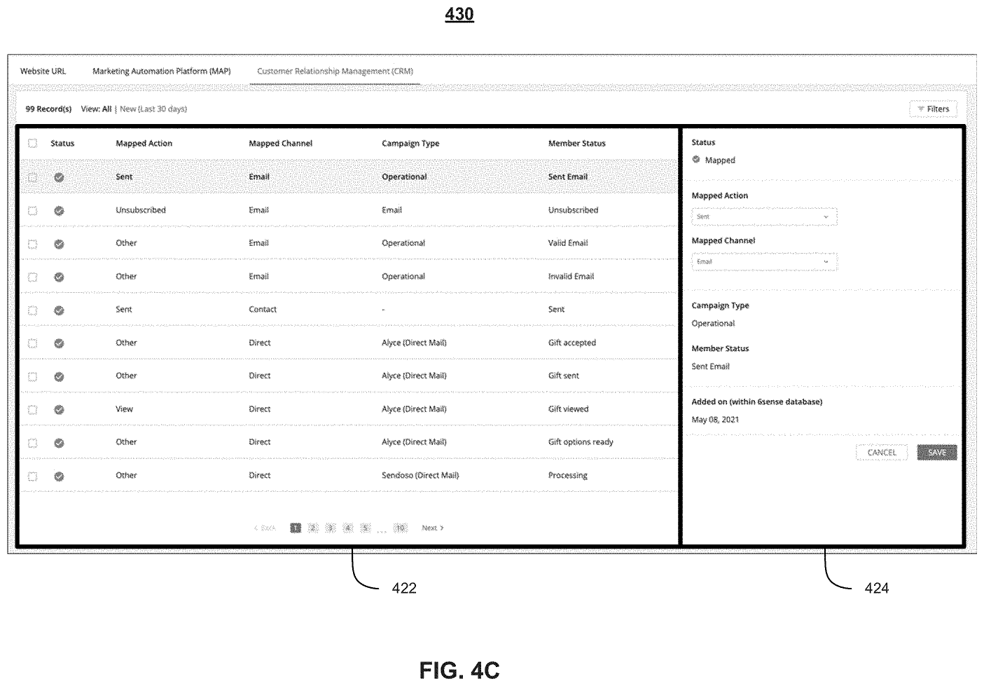

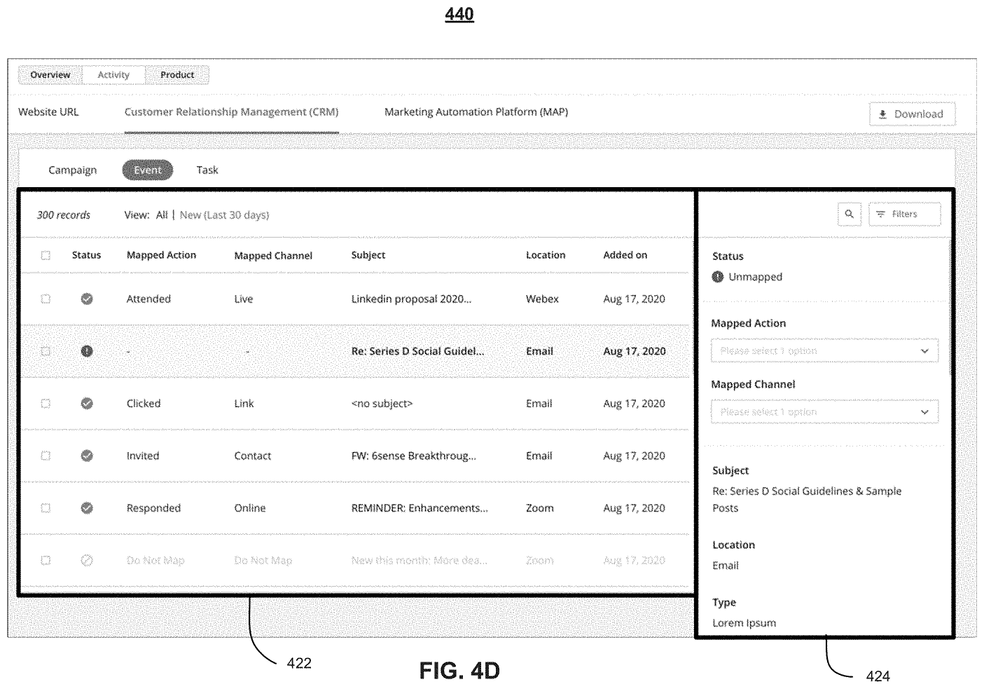

FIGS. 4A-4D illustrate exemplary screens of a graphical user interface, via which the taxonomic classes for activity records may be viewed, confirmed, specified, and/or overridden, according to embodiments. In particular, FIG. 4A illustrates an overview screen 410, FIG. 4B illustrates a MAP-specific activity screen 420, FIG. 4C illustrates a CRM-campaign-specific activity screen 430, and FIG. 4D illustrates a CRM-event-specific activity screen 440.

Overview screen 410 provides an overview of taxonomic classifications associated with a user account. Overview screen 410 may comprise an informational area 412 that notifies the user whether or not there are any action items that are pending or need to be addressed. Overview screen 410 may also comprise a data summary 414 and an activity summary 416. Data summary 414 may indicate the number of data points (i.e., activity records), associated with each data source, that were acquired and processed within a most recent time period (e.g., past month). For example, these data sources may include at least one MAP and at least one CRM system. It should be understood that the MAP may be the MAP managed and utilized by the user's organization and configured under the associated organizational account, and the CRM system may be the CRM system managed and utilized by the user's organization and configured under the associated organizational account. Activity summary 416 may indicate the number of data points with each status (e.g., “unmapped,” “mapped,” and “do no map”) from each data source (e.g., MAP, CRM system, etc.) in a table, grid, chart, or other graphical representation.

Each of MAP-specific activity screen 420, CRM-campaign-specific activity screen 430, and CRM-event-specific activity screen 440 may comprise a list 422 of activity records acquired from the MAP, campaign data from the CRM system, and event data from the CRM system, respectively. List 422 may be filterable (e.g., so that a user may view all entries, entries from the past month, etc.) and/or sortable (e.g., by one or more of the columns of list 422). It should be understood that, depending on the number of entries in list 422 and/or user preference settings, list 422 may be paginated according to a maximum number of entries per page. Each entry in list 422 may comprise a checkbox (e.g., for selecting the entry), a status (e.g., an icon indicating one of “mapped,” “mapped but needs confirmation,” “unmapped,” or “do not map”), action 338 determined for the activity record represented by the entry, channel 348 determined for the activity record represented by the entry, and type 358 and/or web activity 368 for the activity record represented by the entity. In CRM-campaign-specific activity screen 430, each entry in list 422 may also comprise the campaign member status from the activity record represented by the entry. In CRM-event-specific activity screen 440, each entry in list 422 may also comprise the subject of the event in the activity record represented by the entry, the location of that event, and the date of the activity record.

Each entry in list 422 may be selectable. When a user selects an entry, the graphical user interface may populate a frame 424 with details about the activity record represented by the selected entry. These details may comprise the status of the activity record (e.g., “mapped,” “unmapped,” “mapped but needs confirmation,” or “do not map”), an input for selecting the action to be associated with the activity record from all available classes of actions in the relevant taxonomy of actions, an input for selecting the channel to be associated with the activity record from all available classes of channels in the relevant taxonomy of channels, the type associated with the activity record, and/or other details about the activity record. The other details about the activity record in frame 424 may depend on the source of the activity record. For example, the other details for an activity record from a MAP may include the date that the activity record was acquired and/or the like. The other details for an activity record from the campaign data of a CRM system may include the campaign member status, the date that the activity record was acquired, and/or the like. The other details for an activity record from the event data of a CRM system may include the subject of the event, the location of the event, the date that the activity record was acquired, the date of the last update to the activity record (e.g., including an identifier of the individual who updated the activity record), a link for viewing an audit trail of updates, and/or the like. Frame 424 may also comprise one or more inputs for saving any changes to the mappings of the activity record and/or canceling any such changes.

In subprocess 390, the combined taxonomic classification for each activity record, including any overrides received in subprocess 380, is saved, in association with the respective activity record, to a data warehouse. In an embodiment, the combined taxonomic classification for the activity records may be stored outside the data warehouse until a user publishes it (e.g., by selecting an input within the graphical user interface). Thus, a user may review, confirm, and/or override actions 338, channels 348, types 358, and web activities 368 (if applicable) before they are saved, in association with their respective activity records, to the data warehouse. It should be understood that some of the taxonomized activity records may be discarded without being saved to the data warehouse (e.g., those associated with the “do not map” status).

In an embodiment, one or more, including potentially all, of the finally determined taxonomic classes, saved into the data warehouse, may be incorporated into their respective lookup tables 333, 343, 353, and 363. For example, for each activity record, the action features 330 extracted from that activity may be saved as an index to the final determined action, which was saved in subprocess 390 for that activity record, in lookup table 333. Similarly, the channel features 340 extracted from that activity record may be saved as an index to the final determined channel, which was saved in subprocess 390 for that activity record, in lookup table 343. Similarly, the type features 350 extracted from that activity record may be saved as an index to the final determined type, which was saved in subprocess 390 for that activity record, in lookup table 353. In addition, if applicable, the web features 360 extracted for the URL in that activity record may be saved as an index to the final determined web activity, which was saved in subprocess 390 for that activity record, in lookup table 363. In other words, the various lookup tables 333, 343, 353, and 363 are updated with associations between features and taxonomic classes that have generally been reviewed and approved. Thus, lookup tables 333, 343, 353, and 363 may be constantly updated to enable models 336, 346, 356, and 366, respectively, to be bypassed whenever the same activity record is seen for a second time. Advantageously, this avoids the computational expense associated with applying a model, when a particular activity record has been previously processed, thereby improving the speed and efficiency of process 300. However, it should be understood that, in an alternative embodiment, the lookup tables 333, 343, 353, and 363 may be omitted, such that the model is applied to all activity records, regardless of whether or not they have been previously processed. While process 300 would be generally less efficient in such an embodiment, it may be more flexible and dynamic, for example, if models 336, 346, 356, and 366 are updated frequently.

Once saved in the data warehouse, the taxonomized activity records may be used for one or more downstream functions, such as predicting buyer intent and buying stages for leads represented by the activity records, as discussed in greater detail in the related patent applications. The taxonomies classify data, representing lead-related activities and obtained from various sources, into a consistent labeling system to ensure compatibility with these downstream function(s).

In an embodiment, the taxonomized activity records are used to extract features as inputs to one or more downstream predictive models. For example, once assigned to the activity records, the various classes in the taxonomies can be used to weight activities, represented by the activity records, for a sales prediction algorithm and/or intent model. In this case, some classes of activities in a taxonomy, which are more indicative of a future purchase or certain buying stage, may be weighted higher than other classes of activities in the taxonomy, which are less indicative of a future purchase or certain buying stage. These weights may be used to determine how likely, in the form of an intent score, a lead is to purchase a product of the organization, based on their recent activities. This intent score could also be combined with the output of other models to determine a next best action (e.g., a recommended contact), as described in the related patent applications.

Thus, advantageously, the disclosed models imbue a computer with the artificial intelligence to interpret activities, and enables the computer to understand how those activities may influence buying decisions and act on that understanding. These models overcome the obstacles to automating the taxonomization of activity records, so that the manual, time-intensive onboarding process for the systems (e.g., MAP, CRM system, etc.) of a new organizational account can be replaced with a scalable, repeatable, and automated taxonomization process, which can process millions and billions of activity records a day if necessary. The automated taxonomies enable more detailed downstream modeling and analysis that is able to answer important questions, such as was a lead's activity important?, what medium did a lead use?, what kind of action or content was associated with the activity?, and/or the like, as well as combinations of such questions.

2.2. Models

Each of models 336, 346, 356, and 366 may have identical or similar architectures. In particular, each of these models may comprise a machine-learning algorithm. The same models may be used across all user accounts, regardless of the particular data sources (e.g., MAPs, CRM systems, etc.) used by those user accounts. Alternatively, different combinations of models 336, 346, 356, and/or 366 may be used for different user accounts, for example, depending on the particular data sources used by those user accounts.

In an embodiment, different models may be used for each type of data source. For example, a first action model 336 may be used for activity records acquired from a MAP, a second, different action model 336 may be used for activity records acquired from the campaign data of a CRM system, and a third, different action model 336 may be used for activity records acquired from the event data of a CRM system. Similarly, a first channel model 346 may be used for activity records acquired from a MAP, a second, different channel model 346 may be used for activity records acquired from the campaign data of a CRM system, and a third, different channel model 346 may be used for activity records acquired from the event data of a CRM system. Similarly, a first type model 356 may be used for activity records acquired from a MAP, a second, different type model 356 may be used for activity records acquired from the campaign data of a CRM system, and a third, different type model 356 may be used for activity records acquired from the event data of a CRM system. Typically, only activity records acquired from a MAP will have URLs, and the available URL data will be the same regardless of data source. Thus, a single web model 366 may be used from all URLs across all data sources and all types of data sources. It should be understood that, in any case in which different models are used depending on the data source or type of data source, different features (e.g., 330, 340, 350, and 360) may be used as the input to those different models, and those different models may classify those features into different taxonomies (e.g., comprising different classes and/or different numbers of classes).

In an embodiment, each model comprises a neural network with an input layer that accepts the respective features (e.g., 330, 340, 350, or 360), one or more hidden layers that transform the input, and an output layer that outputs the predicted one of the plurality of classes or the probability value for each of the plurality of classes in the relevant taxonomy. The neural network may be a deep neural network comprising a plurality of hidden layers. In a particular implementation, the neural network may be a recurrent neural network (RNN), with long short-term memory (LSTM). LSTM uses feedback connections to process sequences of data, such as sentences. The neural network may utilize a rectified linear activation unit (ReLU) as the activation function for one or more, including potentially all, of the hidden layers, and may utilize the Softmax function as the last activation function for the final classification. During training, a 20% dropout may be used for each layer to reduce overfitting and improve generalization error.

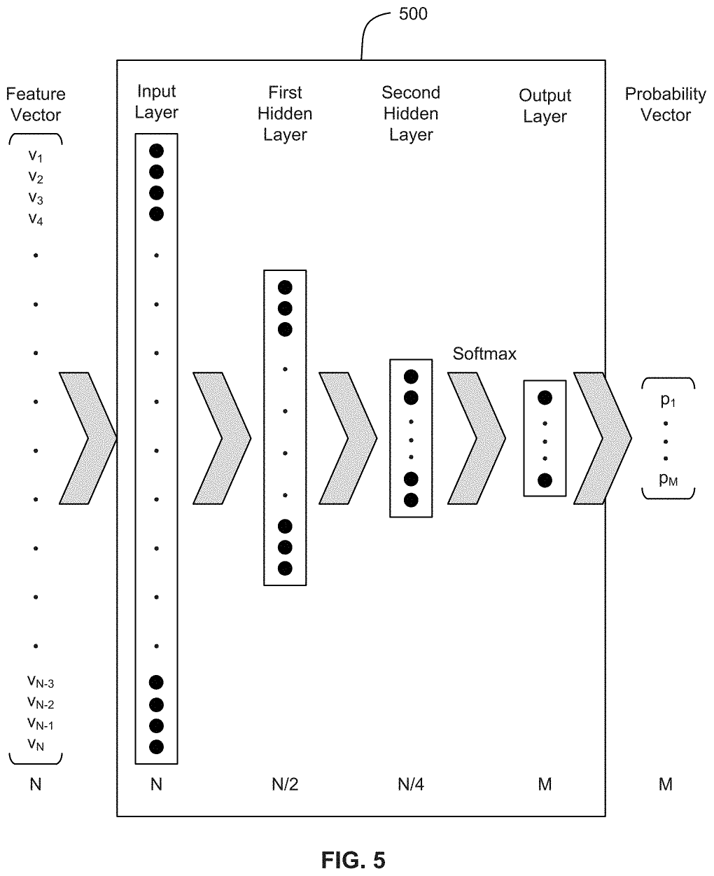

FIG. 5 illustrates an example architecture of a deep neural network 500 that may be used for one or more, including potentially all, of models 336, 346, 356, and/or 366, according to an embodiment. In the illustrated embodiment, the input to dep neural network 500 is an N-dimensional feature vector, output by a vectorization function F_{V}, and representing a textual embedding of a feature string in an N-dimensional vector space. This feature vector is input into a dense input layer comprising N neurons. ReLU may be used as the activation function for the input layer. The first hidden layer may be a dense layer that is half the size of the input layer (i.e., N/2), representing a higher level of abstraction. Again, ReLU may be used as the activation function for the first hidden layer. The second hidden layer may be a dense layer that is half the size of the first hidden layer and a quarter of the size of the input layer (i.e., N/4), representing an even higher level of abstraction. The second hidden layer may feed a Softmax activation function that produces an output layer representing the final classification of the input feature vector. The output layer has a size M that is equal to the number of classes in the relevant taxonomy. The final classification may be output as a probability vector of size M, comprising a probability value for each of the plurality of classes in the relevant taxonomy. The table below illustrates the layers of a particular implementation of a deep neural network 500 in which N=512 and M=11. This particular implementation was constructed layer by layer using a deep-learning library in Python. The model performed very well after a single epoch of training. This is likely due to the well-defined inputs and outputs of the use case, and reinforces the accuracy of the annotated training dataset that was used.

| Layer | Size | No. of Parameters |
|---|---|---|
| Input | 512 | 262,656 |
| First Hidden | 256 | 131,328 |
| Second Hidden | 128 | 32,896 |
| Output | 11 | 1,419 |

The weights of each neural network may be trained using a training dataset to minimize a loss function. The training dataset may comprise feature vectors that have been annotated with ground-truth classes from the relevant taxonomy. If the model is to be used for a plurality of different organizational accounts and/or for data from a plurality of different systems, the training dataset should comprise feature vectors from a plurality of organizations and/or acquired from a plurality of different systems. For example, in a particular implementation, feature vectors were extracted from the data of fifty-eight different organizational accounts to construct the training and testing datasets, and from the data of twenty-seven different organization accounts to construct the validation dataset. The organizational accounts were chosen based on the volume, completion, and breadth of available data, and to represent an almost equal spread of different MAPs (e.g., Marketo™, Eloqua™, Hubspot™, and Pardot™) in the cohorts, so that the resulting models would be MAP-agnostic. The feature vectors in each dataset may be manually annotated with the ground-truth classes from the relevant taxonomy. It should be understood that the same set of feature vectors may be used to train multiple models for different taxonomies, but that the respective datasets will have different annotations. Each neural network, representing each model, is trained to classify respective features into one of the plurality of classes of the relevant taxonomy. Thus, each trained deep neural network represents a deep-learning-based classifier. Since there are a plurality of classes to be predicted by each model, the parameters of each model may be initialized in a multiclass configuration. Multiclass configuration refers to the problem of classifying instances into one of three or more classes.

In an embodiment, transfer learning is used to facilitate the training of each model. In transfer learning, an existing model is used as a starting point or source for training the new model. The existing model may have been previously trained to solve a different or similar problem. In this case, the existing model may have been previously trained for natural language processing. In particular, the neuron weights of a neural network that have been trained for natural language processing may be used as the starting point for training each deep-learning-based classifier.

In an embodiment that utilizes transfer learning, a language transformer is used as the source of transfer learning. In particular, the neuron weights for the base architecture of the trained neural network for an existing language transformer, such as Bidirectional Encoder Representations from Transformers (BERT), may be frozen. BERT is described in “Attention Is All You Need,” by Vaswani et al., 31st Conference on Neural Information Processing Systems (NIPS 2017), arXiv:1706.03762v5, which is hereby incorporated herein by reference as if set forth in full. Then, one or more, and typically several, subsequent layers are added to this base architecture to build a deep neural network that is able to classify language into the plurality of specific classes of the relevant taxonomy. This process is referred to as “fine-tuning.” One advantage of fine-tuning a language transformer to build the model is that the layers of a language transformer hold information about natural language understanding and sentence interpretation, which abstracts the process of breaking sentences into phrases, words, or characters. Hence, this base architecture is able to interpret the input. In addition, transfer learning enables the model to be trained with a fewer number of data points (i.e., activity records), because the language understanding has already been addressed by the base architecture of the existing model. There only needs to be a sufficient number of data points to train the end layers of the neural network to classify the understood language into the specific classes developed for the particular application.

The goal of training is to minimize the error between the ground-truth classes (e.g., the annotations) and the predicted classes (i.e., output by the model). If a predicted class matches the ground-truth class, then the error is minimized for that prediction. The total error of the model may be determined according to a loss function, such that the goal of training is to minimize the loss function. The loss function may be minimized when an error metric computed by the loss function is below a predetermined threshold value, representing a necessary or desired accuracy of the model, or the difference or rate of decrease in the error metric from prior epochs falls below a predetermined threshold value, representing that the loss function cannot be minimized any further. In an embodiment, a cross-entropy loss function may be used as the loss function, along with the Adam optimizer. The training may be performed, for example, using Pytorch or Tensorflow.

Following each iteration or “epoch” of training, the trained model is validated on the validation dataset. In other words, the trained model is applied to the feature vectors in the validation dataset as inputs, to produce predicted classes for each of the feature vectors as outputs. The loss function may then be computed, representing the error between the predicted classes for the feature vectors in the validation dataset and their corresponding ground-truth classes, represented by the annotations of the feature vectors in the validation dataset. If the loss function is not minimized, another epoch of training may be performed. In other words, the model is retrained (e.g., by updating neuron weights of the neural network) on the training dataset until the loss function is minimized.

Once each model has been trained and validated, the model may be evaluated. In particular, the model may be evaluated on a testing dataset comprising feature vectors for which the ground truth is known. The goal of the evaluation is to determine whether the model is suitable for operation. The evaluation may utilize a metric of the model's accuracy to determine whether or not the model passes the evaluation. For example, if the metric satisfies (e.g., exceeds) a predetermined threshold value, the model may be determined to pass the evaluation. Otherwise, if the metric does not satisfy the predetermined threshold value, the model may be determined to not pass the evaluation. If the model does not pass the evaluation, a new training dataset may be constructed (e.g., from the same activity records and/or new activity records) and the model may be retrained.

In a particular implementation, the multiclass F1-score was used as the metric of the model's accuracy. The F1-score is a function of precision (a.k.a., positive predictive value) and recall (a.k.a., sensitivity). Precision is the number of true positive results divided by the number of all positive results for a particular class in the relevant taxonomy, and recall is the number of true positive results divided by the number of all data points that should have been identified as positive for a particular class in the relevant taxonomy. The multiclass F1-score is calculated by combining the F1-scores for each of the classes in the relevant taxonomy, according to a combination strategy (e.g., micro-average, macro-average, weighted average, etc.).

If a model passes the evaluation, the model (e.g., model 336, 346, 356, or 366) and its associated parameters (e.g., neuron weights) may be saved on platform 110, which may comprise a cloud server, for deployment into process 300. Each model may be saved to a shared path in memory (e.g., database 114) for utilization during process 300. Prior to being saved, each model may be streamlined or optimized for performance. For example, in a particular implementation, each model was passed through the Open Neural Network Exchange (ONNX) runtime, which converts the native model into a different format to improve the speed of prediction (e.g., decreasing prediction times by as much as ten times, and by 3.1 times on average). Advantageously, this enabled the model to be operated on a standard CPU during the operation phase, such that a GPU was unnecessary during the operation phase and the model was more portable. Notably, this conversion process only affects how the model is represented. It does not affect the accuracy of the model and may be omitted in other implementations.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
during a training mode, train each of a plurality of models to predict a class, from a plurality of classes in a different one of a plurality of taxonomies than any other one of the plurality of models, based on a training dataset that comprises a plurality of annotated features, wherein the plurality of models comprises an action model that predicts a class in a taxonomy of actions, a channel model that predicts a class in a taxonomy of channels, and a type model that predicts a class in a taxonomy of types; and,
during an operation mode,
acquire data comprising one or more activity records,
for each of the one or more activity records,
extract action features, channel features, and type features from the activity record,
apply the action model to the action features to predict an action class from the taxonomy of actions,
apply the channel model to the channel features to predict a channel class from the taxonomy of channels,
apply the type model to the type features to predict a type class from the taxonomy of types, and
store the predicted action class, the predicted channel class, and the predicted type class in association with the activity record as a taxonomized activity record.

2. The method of claim 1, wherein extracting the action features, extracting the channel features, and extracting the type features each comprises:
deriving one or more keywords from the activity record; and
converting the one or more keywords into a vector according to a vectorization function.

3. The method of claim 2, wherein each vector has a fixed number of dimensions and represents an embedding of the one or more keywords within a vector space having the fixed number of dimensions.

4. The method of claim 3, wherein the vectorization function is a language transformer.

5. The method of claim 3, wherein the vector comprises a real value for each of the fixed number of dimensions.

6. The method of claim 2, wherein extracting the action features, extracting the channel features, and extracting the type features each further comprises, normalizing the one or more keywords prior to converting the one or more keywords into the vector.

7. The method of claim 1, wherein each of the plurality of models comprises a deep neural network.

8. The method of claim 7, wherein training each of the plurality of models comprises adding one or more layers to an existing neural network trained for natural language processing, while neuron weights in one or more layers of the existing neural network are frozen.

9. The method of claim 7, wherein each of the plurality of models outputs both a predicted class and a probability value for the predicted class, and wherein the method further comprises using the at least one hardware processor to, during the operation mode, for each of the one or more activity records:
when the probability values for the predicted classes by all of the plurality of models satisfy respective thresholds, assign a mapped status to the activity record; and,
when the probability value for the predicted class from at least one of the plurality of models does not satisfy the respective threshold, assign an unmapped status to the activity record.

10. The method of claim 9, wherein the method further comprises using the at least one hardware processor to:
generate a graphical user interface that comprises, for each of the activity records to which the unmapped status has been assigned, one or more inputs for specifying one of the plurality of classes in two or more of the plurality of taxonomies to be associated with that activity record; and,
in response to a user operation to save one of the activity records to which the unmapped status has been assigned, store any specified classes in association with the one activity record, and assign the mapped status to the one activity record.

11. The method of claim 1, wherein the method further comprises using the at least one hardware processor to generate a graphical user interface that comprises one or more inputs for changing each of one or both of the stored action class and the stored channel class to an overriding class in one or more of the taxonomized activity records, and at least one input for storing the one or more taxonomized activity records, including any overriding classes, in a data warehouse.

12. The method of claim 11, further comprising using the at least one hardware processor to generate at least one lookup table from the data warehouse, wherein the at least one lookup table indexes one or more of:
the action class in each of one or more of the taxonomized activity records in the data warehouse by the action features of that taxonomized activity record;
the channel class in each of one or more of the taxonomized activity records in the data warehouse by the channel features of that taxonomized activity record; or
the type class in each of one or more of the taxonomized activity records in the data warehouse by the type features of that taxonomized activity record.

13. The method of claim 12, further comprising using the at least one hardware processor to, for each of one or more activity records, for each of the plurality of models:
perform a lookup in the at least one lookup table using features extracted for that model from the activity record;
when the lookup returns a class, store the returned class in association with the activity record as the taxonomized activity record without applying the model; and,
when the lookup does not return a class, extract the features for that model, and apply the model to the extracted features.

14. The method of claim 1, wherein the plurality of models further comprises a web model that predicts a class in a taxonomy of web activities, and wherein the method further comprises using the at least one hardware processor to, during the operation mode, for each of the one or more activity records, when the activity record contains a uniform resource locator (URL):
extract web features from the activity record;
apply the web model to the web features to predict a web activity from the taxonomy of web activities; and
store the predicted web activity in association with the activity record in the taxonomized activity record.

15. The method of claim 14, wherein, during the operation mode, for each of the one or more activity records, when the activity record contains a URL, the predicted web activity is associated with the activity record in the taxonomized activity record instead of the predicted type class.

16. The method of claim 1, wherein the plurality of models comprise a plurality of action models, a plurality of channel models, and a plurality of type models, and wherein the method further comprises using the at least one hardware processor to, during the operation mode, select one of the plurality of action models, one of the plurality of channel models, and one of the plurality of type models based on a type of data source from which the data was acquired.

17. The method of claim 16, wherein a first combination of one of the plurality of action models, one of the plurality of channel models, and one of the plurality of type models is selected when the type of data source is a marketing automation platform, and a second combination of one of the plurality of action models, one of the plurality of channel models, and one of the plurality of type models is selected when the type of data source is a customer relationship management system, and wherein the first combination is different than the second combination.

18. The method of claim 16, wherein a first combination of one of the plurality of action models, one of the plurality of channel models, and one of the plurality of type models is selected when the type of data source is a marketing automation platform, a second combination of one of the plurality of action models, one of the plurality of channel models, and one of the plurality of type models is selected when the type of data source is campaign data of a customer relationship management system, and a third combination of one of the plurality of action models, one of the plurality of channel models, and one of the plurality of type models is selected when the type of data source is event data of a customer relationship management system, and wherein the first combination, the second combination, and the third combination are different from each other.

19. A system comprising:
at least one hardware processor; and
one or more software modules that are configured to, when executed by the at least one hardware processor,
during a training mode, train each of a plurality of models to predict a class, from a plurality of classes in a different one of a plurality of taxonomies than any other one of the plurality of models, based on a training dataset that comprises a plurality of annotated features, wherein the plurality of models comprises an action model that predicts a class in a taxonomy of actions, a channel model that predicts a class in a taxonomy of channels, and a type model that predicts a class in a taxonomy of types, and,
during an operation mode,
acquire data comprising one or more activity records,
for each of the one or more activity records,
extract action features, channel features, and type features from the activity record,
apply the action model to the action features to predict an action class from the taxonomy of actions,
apply the channel model to the channel features to predict a channel class from the taxonomy of channels,
apply the type model to the type features to predict a type class from the taxonomy of types, and
store the predicted action class, the predicted channel class, and the predicted type class in association with the activity record as a taxonomized activity record.

20. A non-transitory computer-readable medium having instructions stored therein, wherein the instructions, when executed by a processor, cause the processor to:
during a training mode, train each of a plurality of models to predict a class, from a plurality of classes in a different one of a plurality of taxonomies than any other one of the plurality of models, based on a training dataset that comprises a plurality of annotated features, wherein the plurality of models comprises an action model that predicts a class in a taxonomy of actions, a channel model that predicts a class in a taxonomy of channels, and a type model that predicts a class in a taxonomy of types; and,
during an operation mode,
acquire data comprising one or more activity records,
for each of the one or more activity records,
extract action features, channel features, and type features from the activity record,
apply the action model to the action features to predict an action class from the taxonomy of actions,
apply the channel model to the channel features to predict a channel class from the taxonomy of channels,
apply the type model to the type features to predict a type class from the taxonomy of types, and
store the predicted action class, the predicted channel class, and the predicted type class in association with the activity record as a taxonomized activity record.
